(19) United States
(12) Patent Application Publication
(10) Pub. No.: US 2017/0140624 A1
(43) Pub. Date: May 18, 2017

(54) Method for Eliminating Thermal Interference for Infrared and Video-Based Early Fire Detection

(71) Applicant: Albert Orglmeister, Wiesbaden (DE)

(72) Inventor: Albert Orglmeister, Wiesbaden (DE)

(21) Appl. No.: 15/333,254

(22) Filed: Oct. 25, 2016

(30) Foreign Application Priority Data
Nov. 13, 2015 (DE) 102015119594.1

(51) Int. Cl. G08B 17/12; H04R 1/32

(52) U.S. Cl. CPC G08B 17/125; H04R 1/326; G10L 25/51

(57) ABSTRACT

The invention relates to a process for the elimination of thermal interferences in the infrared and video fire detection at an early stage in waste incineration plants, recycling facilities, warehouses and the like. The process is characterized by an additional noise and vibration analysis, by measuring the noise level of vehicles situated in the area to be detected or other thermal interference sources, with a distinction in measuring the noise level between day mode and night mode. The volume thresholds can thus be determined and be used as a threshold for determining whether a fire extinguishing sequence should be triggered.

### CROSS REFERENCE TO RELATED APPLICATIONS

This application claims the priority of DE 102015119594.1 filed on Nov. 13, 2015; this application is incorporated by reference herein in its entirety.

### BACKGROUND

The invention refers to a process for eliminating thermal interference for infrared and video-based early fire detection in waste incineration plants, recycling facilities, warehouses and the like.

Different sensor systems are known that can detect a fire. Furthermore, there are various extinguishing systems with which fires are extinguished in industrial plants or larger rooms. Typically, a fire is detected and a fire extinguishing system is switched on, thereby spraying a large amount of extinguishing agent such as water or foam, in the fire area, flooding and thus extinguishes the fire. Of greatest importance is the detection of a fire. This takes place in particular by means of thermal differential detectors, smoke fire detectors, aspirating smoke detectors, flame detectors, infrared detectors and infrared cameras.

In particular sprinkler systems, which are significantly more powerful deluge facilities and manually controlled fire monitors can be used as extinguishing systems. The latter are referred to as cannons or as a water throwers.

Increasingly, more and more infrared detectors, in particular infrared cameras and video cameras, have been used for early fire detection in waste incineration plants, recycling plants, warehouses and the like.

Fire detection with fire detection systems based on infrared cameras is triggered when a limit temperature has been exceeded.

With video-based systems, fire detection is triggered by smoke detection, flame detection or by evaluating the short-wave infrared portion.

For example, in a warehouse, loaded with recycled materials, a temperature threshold of 80° C. as a fire alarm temperature is often defined as fire triggering temperature. The temperature is the one selected to be high so as not to detect self-heating by fermentation processes in the recycled material as a fire trigger. On the other hand, the alarm temperature is selected to be as low as possible in order to detect fires as soon as possible, which are located inside a material heap, or its rising convection heat that penetrates the surface of the material pile.

This method has proven itself and functions smoothly as long as there are no thermal interferences. These are generated for example by a hot exhaust or hot engine of a wheel loader. In operation, peak temperatures up to 500° C. can be achieved here quickly.

Currently, it has been attempted to eliminate these thermal interferences by using temperature and magnitude ratios. For example, the surface of an exhaust pipe of a wheel loader with a temperature limit of 80° C. quickly reaches a limit temperature exceeding area of 1 m². This means that currently at least an area of 1 m² must be detected above 80° C., to trigger a fire alarm. In everyday use, this area can even be increased. Consequently, the surface of the hot engine and the heated body parts near the engine is thus added to the exhaust area. It is also possible that juxtaposed wheel loaders and other vehicles combine to increase the size of disruptive areas. Since the distances between the infrared detection system and the vehicles vary, a tolerance must be factored in when determining the size of the limit temperature exceeding area. Ultimately, as soon the limit temperature exceeding area rises to 3 m².

The advantage of early detection by infrared and video analysis is considerably weakened because such a large contiguous area that exceeds 80° C. in an aggregate material, requires a huge fire in said aggregate material. Also, a second higher limit temperature, for example at 200° C., does not change the result significantly. The smaller detection surface works in combination with a higher limit temperature, but again has the disadvantage that a concealed fire already has a significant size in an aggregate material.

Analysis now relate to the color, shape and markings to be able to identify the interferences clearly and include the considerable soil load of the objects and the fact that hot interfering objects such as an exhaust of vehicles, which are driven from the rain in a hall, behave exactly at a thermal image analysis as an initial fire whose temperature limit exceeding borders expand.

Furthermore, a distinction is made between the so-called “Day mode”, when vehicles may run within the area to be monitored for fire, and “Night mode”, when vehicles and other thermal interference sources such as thermal drive motors of machinery are not authorized.

### SUMMARY

The invention relates to a process for the elimination of thermal interferences in the infrared and video fire detection at an early stage in waste incineration plants, recycling facilities, warehouses and the like. The process is characterized by an additional noise and vibration analysis, by measuring the noise level of vehicles situated in the area to be detected or other thermal interference sources, with a distinction in measuring the noise level between day mode and night mode. The volume thresholds can thus be determined and be used as a threshold for determining whether a fire extinguishing sequence should be triggered.

### DETAILED DESCRIPTION

The object of the invention is to provide a method for eliminating thermal problems in the infrared and video fire detection at an early stage in waste incineration plants, recycling facilities, warehouses and the like, allowing safe fire detection at an early stage with the elimination of so many thermal interferences as possible.

According to the invention, the object is achieved by an additional noise and vibration analysis by measuring the noise level of vehicles situated in the area to be detected or other thermal interference sources, such as drive motors of machines, with a distinction in measuring the noise level between day mode and night mode, and the volume thresholds are determined and can be used as a threshold for determining whether a fire extinguishing sequence should be initiated.

Thus, the currently known methods of analysis, namely infrared and/or video fire detection at an early stage, are combined with sound or vibration detection in order to discriminate whether vehicles or other thermal interference sources, such as in particular drive motors of machinery, are situated in the area to be detected, in incinerators, recycling facilities, warehouses and the like.

According to another embodiment of the method of the invention, the noise and vibration analysis can be permanent and/or time-controlled.

Furthermore, the volume levels are determined for the non-working operation, such as night mode, and the operating mode, for example, during daytime. The volume thresholds determined with the noise and vibration analysis are then used as a threshold for determining whether a fire extinguishing sequence is triggered.

According to another embodiment of the solution of the inventive, analog and/or digital filters, directional microphones, external microphones for a 3-dimensional noise pattern, brand specific noise filters and/or vibration sensors are used for noise and vibration analysis.

Using analog and/or digital filters in the noise analysis thus enables to establish which vehicle or which type of vehicle, including wheel loaders, trucks or the like, is the area to be detected or whether it is a specific operating area of facilities to be monitored. Here also interference noises external to the facilities can be filtered out.

Alternatively, when a directional microphone is used, in parallel with the infrared or video analysis, the interference can be associated locally with the object currently detected. It is also possible to use several directional microphones.

Using external microphones and a 3-dimensional noise pattern may provide clues about appliances in operation and integrate these into the analysis.

The noise analysis can also be used to detect a fire, whereby brand specific noise filters are used for analysis. Consequently, combination with the infrared and/or video analysis provides for an even better decision whether we are dealing with a fire or an interference.

Finally, instead of conventional microphones, vibration sensors, in particular low-frequency microphones, can be used to analyze noises in the low frequency range or sub-frequency range.

It goes with saying that the features aforementioned and those still to be explained below cannot solely be applied in the given combination, but also in other combinations or individually, without departing from the framework of the present invention.

### BRIEF DESCRIPTION OF THE DRAWINGS

The drawings show schematic diagrams of the interference detection via noise analysis for the detection of fires.

FIG. 1 shows sensors, analysis and the signal output;

FIG. 2 shows a processing facility and operating noise in the processing facility;

FIG. 3 shows interference via operating noise of a vehicle; and

FIG. 4 shows material that is being monitored for a fire and a possible hotspot.

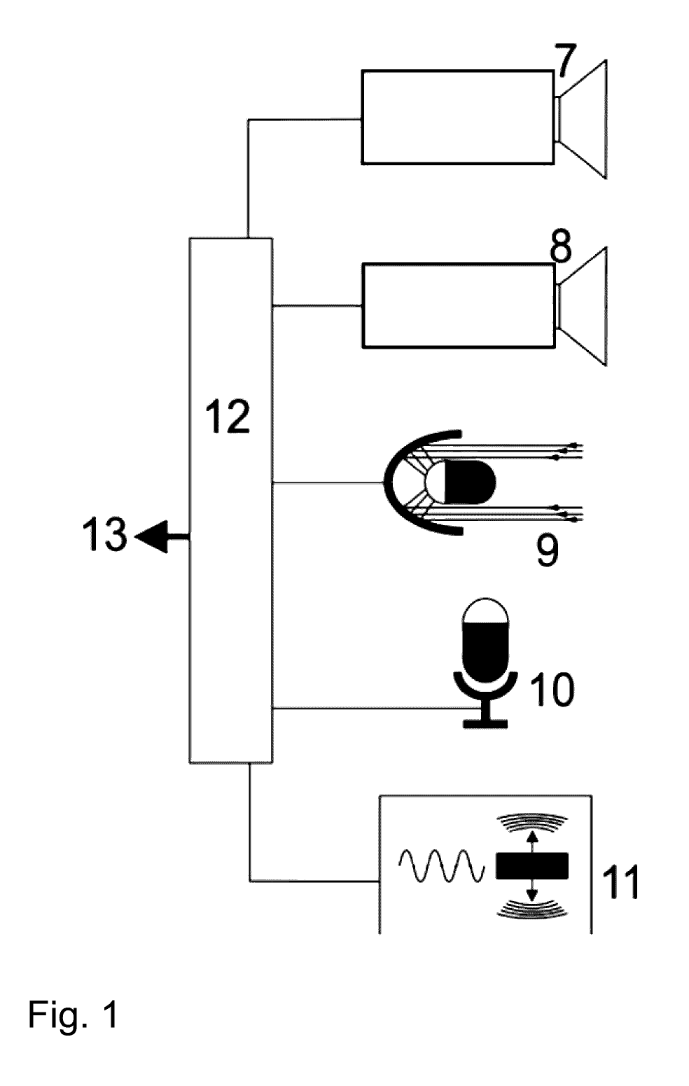

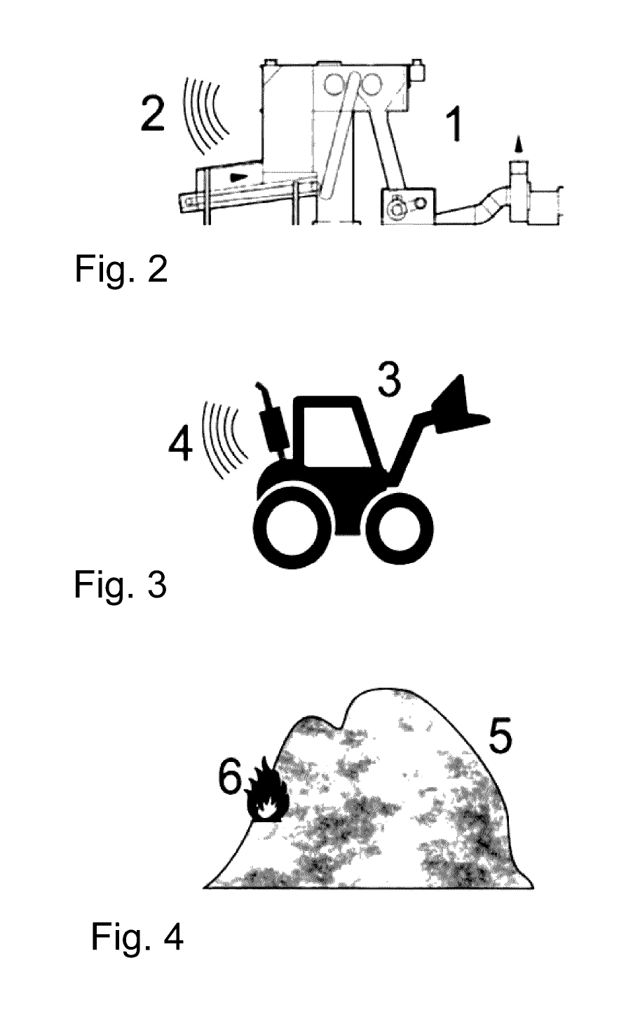

### LIST OF REFERENCE NUMERALS

1 Processing facility (e.g. for processing of recycling material)
2 Operating noise in the processing facility
3 Interference of a motor vehicle (e.g. exhaust of a wheel loader)
4 Operating noise of the wheel loader
5 Material that is being monitored for a fire
6 Hotspot (possible cause of a fire or hidden fire)
7 IR camera (thermal image camera)
8 Video camera
9 Directional microphone
10 External microphone
11 Vibration sensor
12 Analysis
13 Signal output: fire or hot interference signal (and thus no fire)

1. A method for the elimination of thermal interferences in the infrared and video fire detection at an early stage in waste incineration plants, recycling facilities, warehouses and the like, characterized by an additional noise and vibration analysis by measuring the noise level of vehicles situated in the area to be detected or other thermal interference sources, such as drive motors of machines, with a distinction in measuring the noise level between day mode and night mode, and the volume thresholds are determined and can be used as a threshold for determining whether a fire extinguishing sequence should be initiated.

2. A method according to claim 1, characterized in that the noise and vibration analysis can be permanent and/or time-controlled.

3. A method according to claim 1, characterized in that the volume levels are determined for the non-working operation, such as night mode, and the operating mode, for example, during daytime.

4. A method according to claim 1, characterized in that analog and/or digital filters, directional microphones, external microphones for a 3-dimensional noise pattern, brand specific noise filters and/or vibration sensors are used for noise and vibration analysis.
